(19) United States
(12) Patent Application Publication
(10) Pub. No.: US 2017/0156083 A1
(43) Pub. Date: Jun. 1, 2017

(54) MAINTAINING PERSISTENT MOBILE DEVICE SESSION

(71) Applicant: Zynga Inc., San Francisco, CA (US)

(72) Inventor: Andrew William Finkenstadt, Pittsburg, CA (US)

(21) Appl. No.: 15/364,453

(22) Filed: Nov. 30, 2016

Related U.S. Application Data
(60) Provisional application No. 62/260,931, filed on Nov. 30, 2015.

(51) Int. Cl. H04W 36/00; H04L 29/08; H04W 36/14

(52) U.S. Cl. CPC H04W 36/0011; H04W 36/14; H04L 67/146

(57) ABSTRACT

Techniques for maintaining a game session when a client device transitions between a first wireless connection and a second wireless connection are described herein. The client device can receive, using a first wireless connection, a first packet having a unique session identifier associated with a game session. Additionally, the client device can determine that a connection quality associated with the first wireless connection is below a predetermined threshold, and in response to the determination, select a different connection type from a priority list. Moreover, the client device can send, using the different connection type, an acknowledgement for the received first packet. The acknowledgement can include the unique session identifier. Furthermore, the client device can establish a second wireless connection using the different connection type. Subsequently, the client device can receive, using the second wireless connection, a second packet from the game server associated with the game session based on the acknowledgement.

### PRIORITY CLAIM

This application claims priority under 35 U.S.C. 119(e) to U.S. Provisional Patent Application Ser. No. 62/260,931, filed Nov. 30, 2015, which is incorporated herein by reference in its entirety.

### TECHNICAL FIELD

The present disclosure generally relates to session management in a wireless communication system and, in particular embodiments, to techniques for maintaining a game session while a user transitions from a first wireless connection to a second wireless connection.

### BACKGROUND

In current implementations, when a user transitions from a first wireless connection (e.g., Wi-Fi connection) to a second wireless connection (Long-Term Evolution (LTE) connection), a game session for a mobile game application becomes disconnected. The user may need to resynchronize or reload the game session in order to continuing playing the mobile game application. Such delays can be problematic when a user is playing a mobile game application, especially when the user's response in the mobile game application is time-critical.

### BRIEF DESCRIPTION OF THE DRAWINGS

FIG. 1 is a schematic diagram showing an example of a system, according to some example embodiments.

FIG. 2 is a block diagram illustrating components of a high-speed protocol translator (HSPT), according to some example embodiments.

FIG. 3 illustrates a diagram of a client device seamlessly communicating with the game networking system using the HSPT when transitioning from a first wireless connection to a second wireless connection, according to various embodiments.

FIG. 4 is a flowchart showing an example method of seamlessly maintaining a game session when a client device transitions from a first wireless connection to a second wireless connection, according to some embodiments.

FIG. 5 is a flowchart showing another example method of seamlessly maintaining a game session when a client device transitions from a first wireless connection to a second wireless connection, according to some embodiments.

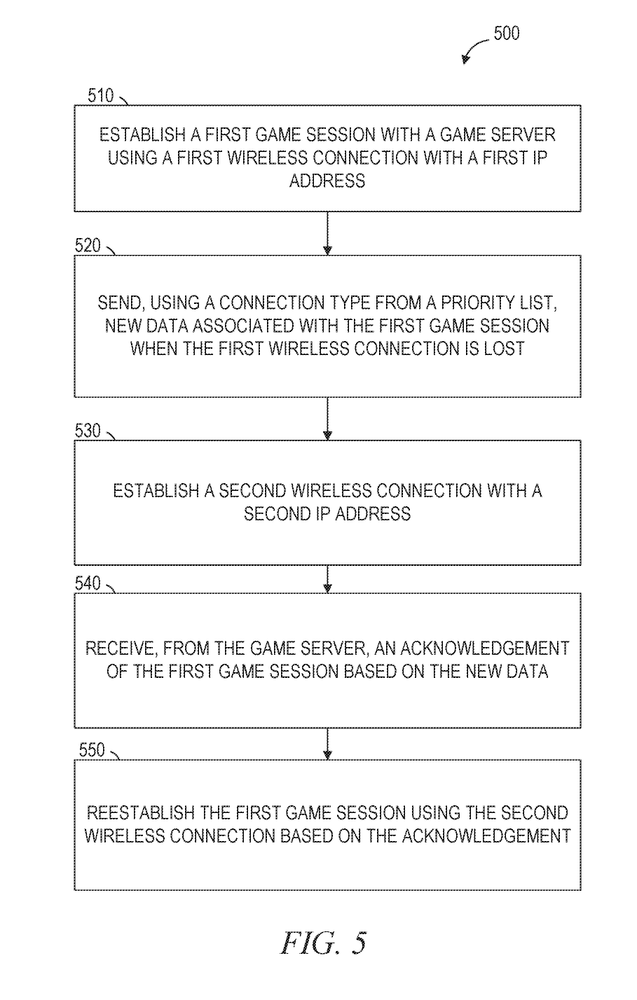

FIG. 6 is a diagrammatic representation of an example data flow between the HSPT, the client device, and the game networking server, according to some example embodiments.

FIG. 7 illustrates an example computing system architecture, according to some example embodiments.

### DETAILED DESCRIPTION

A system, a machine-readable storage medium storing instructions, and a computer-implemented method are described herein to seamlessly transition a game session of a mobile game application when a user moves from a first wireless connection to a second wireless connection. In the following description, for purposes of explanation, numerous specific details are set forth in order to provide a thorough understanding of example embodiments. It will be evident, however, to one skilled in the art, that the present technology may be practiced without these specific details.

According to various embodiments, a high-speed protocol translator (HSPT) can assist a mobile game application in maintaining the game session without the user having to reload or resynchronize the game session. The HSPT can allow the game session to automatically continue when the user transitions from a first wireless connection to a second wireless connection.

For example, in many mobile game applications, a game user may need to receive continuous alerts and updates. As a result, the user can be alerted at any time by a mobile game application, and the user's response can be time-critical.

As previously mentioned, in current implementations, when a user transitions from a first wireless connection (e.g., Wi-Fi connection) to a second wireless connection (LTE connection), the user may need to resynchronize the mobile game application or reload the mobile game application. For example, the user can initially be playing a mobile game application at home using the home's Wi-Fi connection. Continuing with the example, when the user leaves home, the Wi-Fi connection is lost. In some instances, the user reconnects to the mobile game application using his cellular service (e.g., LTE connection). However, the game session becomes disconnected during the transition. The user may need to manually resynchronize the game or manually reload the game. Such delays can be problematic when a user is playing a mobile game application, especially when the user's response is time-critical.

In some instances, the HSPT can maintain a real-time responsive Internet-based game play or game view session while a mobile device (e.g., handheld device, Wi-Fi capable computer) transitions between networks under different Internet Protocol (IP) address zones. The transition can include the mobile device switching between differently managed Wi-Fi networks (e.g., public, known Wi-Fi networks) and mobile carriers. The mobile carrier can have varying levels of data transport.

For example, the mobile device can switch between a public Wi-Fi connection at a coffee shop and a known Wi-Fi connection at the user's office. In another example, the mobile device can switch between a home Wi-Fi connection and the user's home mobile carrier. In yet another example, the mobile device can switch between the user's home mobile carrier and a roaming mobile carrier.

In current implementation, when the mobile device transitions between networks, the IP address for the game application changes, which results in a reconnection event. The reconnection event can result in a loss of state and real-time stream of data.

According to some embodiments, the HSPT acts as an intermediary between the mobile device and the game services running the Internet-based game application. The HSPT maintains the virtual circuit between the end points even when the user transitions from a first wireless connection to a second wireless connection (e.g., during a change of an IP address).

In some instances, the quality of the Internet connection between the HSPT and the mobile device can vary over time. For example, the HSPT can determine or receive connection characteristics (e.g., packet loss, latency, bandwidth) of the internet connection, and modify the Internet connection based the connection parameters. Additionally, the HSPT can modify the Internet connection based on other parameters such as the IP address and connection type (e.g., Bluetooth, Wi-Fi, LTE, mobile carrier roaming, and other network zones of administration). The HSPT can remove the appearance of a total loss of connectivity while transitioning across these boundaries.

According to some embodiment, the system uses a prioritized list of connections for maintaining the actual connectivity between the mobile device and the HSPT. The prioritized list can include user datagram protocol (UDP), transmission control protocol (TCP), socket secure (SOCKS), Hypertext Transfer Protocol (HTTP), or HTTP proxies. The prioritized list can allow the HSPT to accept and deliver packets bound bi-directionally with the mobile device during a transition between the first and second wireless connections. In some instances, HSPT can constantly measure the “line quality” (e.g., connection quality) of the connection method in the prioritized list in order to optimize the player experience. For example, if the HSPT determines that the packet loss is greater than a predetermined threshold for the first connection type (e.g., UDP) in the prioritized list, then the HSPT can connect to the mobile device using the second connection type (e.g., TCP) in the prioritized list.

In the rare case of failure (e.g., DNS failure, provider blackout, provider blocking, service outage) when the line quality measurements make the use of HSPT difficult, the mobile device can fall back to using direct connections to the game application service. The direct connections to the game application service can be a conventional connection without the HSPT, such as a current implementation of connecting a mobile device session.

The networking stack of the HSPT can provide resiliency and robustness against high latency, packet loss, and dropped connections. The HSPT can also make a game session mobile device more power efficient and reduce drain on a battery. For example, by keeping a continuous link for the game session, the mobile device doesn't have to waste power searching for a new connection link or reestablishing the game session. The stack of the HSPT can use a persistent TCP/IP or UDP connection to send messages back and forth between the server and client in order to provide more resiliency and robustness.

It is to be understood that various embodiments include the generation of one or more modules that comprise source code that, when compiled by a computing device(s), creates object code that causes the computing device(s) to perform one or more operations described herein. In other embodiments, any of the modules comprise object code that causes the computing device(s) to perform various operations described herein.

Other embodiments include the generation of one or more modules that comprise source code that, when compiled by a client computing device(s), creates object code that causes the client computing device(s) to perform one or more operations described herein in communication with a server computing device(s). In other embodiments, any of the modules comprise object code that causes the client computing device(s) to perform various operations described herein in communication with the server computing device(s).

Other embodiments include the generation of one or more modules that comprise source code that, when compiled by a server computing device(s), creates object code that causes the server computing device(s) to perform one or more operations described herein in communication with one or more client computing devices. In other embodiments, any of the modules comprise object code that causes the server computing device(s) to perform various operations described herein in communication with the one or more client computing devices.

### Social Networking Systems and Game Networking Systems

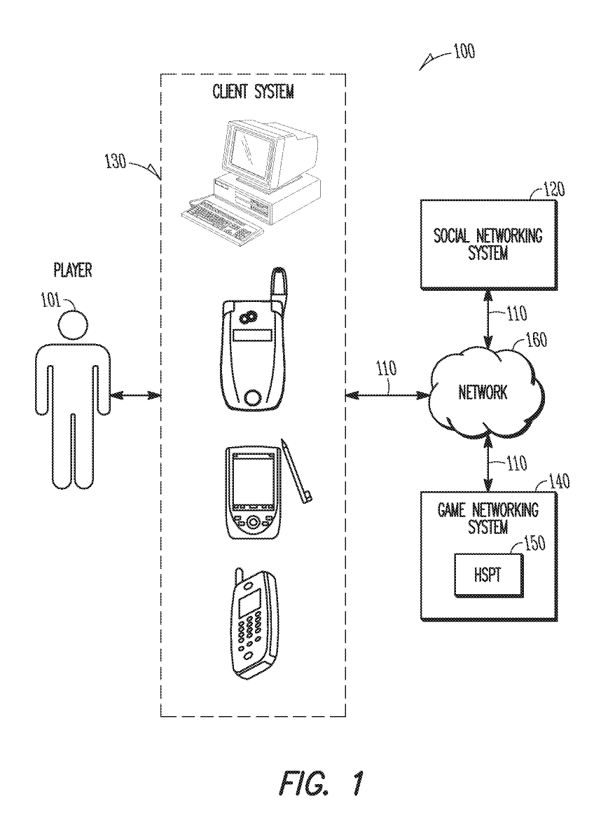

FIG. 1 illustrates an example of a system 100 for implementing various disclosed embodiments. In particular embodiments, the system 100 comprises a player 101, a social networking system 120, a game networking system 140 (i.e., online gaming system), a client system 130, and a network 160. The components of the system 100 can be connected to each other in any suitable configuration, using any suitable type of connection. The components may be connected directly or via the network 160, which may be any suitable network. For example, one or more portions of the network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, another type of network, or a combination of two or more such networks.

The social networking system 120 is a network-addressable computing system that can host one or more social graphs. The social networking system 120 can generate, store, receive, and transmit social networking data. The social networking system 120 can be accessed by the other components of the system 100 either directly or via the network 160. The game networking system 140 is a network-addressable computing system that can host one or more online games. The game networking system 140 can generate, store, receive, and transmit game-related data, such as, for example, game account data, game input, game state data, and game displays. The game networking system 140 can be accessed by the other components of the system 100 either directly or via the network 160. The player 101 may use the client system 130 to access, send data to, and receive data from the social networking system 120 and the game networking system 140 using the HSPT. The client system 130 can access the social networking system 120 or the game networking system 140 directly using the HSPT via the network 160. As an example, and not by way of limitation, the client system 130 may access the game networking system 140 via the social networking system 120. The client system 130 can be any suitable computing device, such as a personal computer, laptop, cellular phone, smartphone, computing tablet, etc.

Although FIG. 1 illustrates a particular number of players 101, social networking systems 120, game networking systems 140, client systems 130, and networks 160, this disclosure contemplates any suitable number of players 101, social networking systems 120, game networking systems 140, client systems 130, and networks 160. As an example and not by way of limitation, the system 100 may include one or more game networking systems 140 and no social networking systems 120. As another example and not by way of limitation, the system 100 may include a system that comprises both the social networking system 120 and the game networking system 140. Moreover, although FIG. 1 illustrates a particular arrangement of the player 101, the social networking system 120, the game networking system 140, the client system 130, and the network 160, this disclosure contemplates any suitable arrangement of the player 101, the social networking system 120, the game networking system 140, the client system 130, and the network 160.

The components of the system 100 may be connected to each other using any suitable connections 110 using the HSPT. For example, suitable connections 110 include wireline (such as, for example, digital subscriber line (DSL) or Data Over Cable Service Interface Specification (DOCSIS)), wireless (such as, for example, Wi-Fi or Worldwide Interoperability for Microwave Access (WiMAX)), or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, another type of connection, or a combination of two or more such connections. The connections 110 need not necessarily be the same throughout the system 100. One or more first connections 110 may differ in one or more respects from one or more second connections 110. Although FIG. 1 illustrates particular connections 110 among the player 101, the social networking system 120, the game networking system 140, the client system 130, and the network 160, this disclosure contemplates any suitable connections 110 among the player 101, the social networking system 120, the game networking system 140, the client system 130, and the network 160. As an example, and not by way of limitation, in particular embodiments, the client system 130 may have a direct connection 110 to the social networking system 120 or the game networking system 140, bypassing the network 160.

### Online Games and Game Systems

In an online computer game, a game engine manages the game state of the game. The game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs) and in-game objects. The game engine also manages the game state, including player character states for currently active (online) and inactive (offline) players 101.

An online game can be hosted by the game networking system 140 (i.e., online gaming system), which includes a notification generator that performs operations according to embodiments as described herein. The game networking system 140 can be accessed using any suitable connection 110 with a suitable client system 130. A player 101 may have a game account on the game networking system 140, wherein the game account can contain a variety of information associated with the player 101 (e.g., the player 101's personal information, financial information, purchase history, player character state, game state). In some embodiments, a player 101 may play multiple games on the game networking system 140, which may maintain a single game account for the player 101 with respect to all the games, or multiple individual game accounts for the player 101 with respect to each game. In some embodiments, the game networking system 140 can assign a unique identifier to each player 101 of an online game hosted on the game networking system 140. The game networking system 140 can determine that a player 101 is accessing the online game by reading the player 101′s cookies, which may be appended to HTTP requests transmitted by the client system 130, and/or by the player 101 logging onto the online game.

In particular embodiments, the player 101 may access an online game and control the game's progress via the client system 130 (e.g., by inputting commands to the game at the client system 130). The client system 130 can display the game interface, receive inputs from the player 101, transmit user inputs or other events to the game engine, and receive instructions from the game engine. The game engine can be executed on any suitable system (such as, for example, the client system 130, the social networking system 120, or the game networking system 140). As an example, and not by way of limitation, the client system 130 can download client components of an online game, which are executed locally, while a remote game networking system, such as the game networking system 140, provides backend support for the client components and may be responsible for maintaining application data of the game, processing the inputs from the player 101, updating and/or synchronizing the game state based on the game logic and each input from the player 101, and transmitting instructions to the client system 130. As another example, and not by way of limitation, each time the player 101 provides an input to the game through the client system 130 (such as, for example, by typing on the keyboard or clicking the mouse of the client system 130), the client components of the game may transmit the player 101's input to the game networking system 140.

### Storing Game-Related Data

A database may store any data relating to game play within a game networking system 140. The database may include database tables for storing a player game state that may include information about the player 101's virtual game board, the player 101's character, or other game-related information. For example, the player game state may include virtual objects owned or used by the player 101, placement positions for virtual structural objects in the player 101's virtual game board, and the like. The player game state may also include in-game obstacles or tasks for the player 101 (e.g., new obstacles, current obstacles, completed obstacles, etc.), the player 101's character attributes (e.g., character health, character energy, amount of coins, amount of cash or virtual currency, etc.), and the like.

The database may also include database tables for storing a player profile that may include user-provided player information that is gathered from the player 101, the player 101's client device, or an affiliate social network. The user-provided player information may include the player 101's demographic information, the player 101's location information (e.g., a historical record of the player 101's location during game play as determined via a GPS-enabled device or the Internet Protocol (IP) address for the player 101's client device), the player 101's localization information (e.g., a list of languages chosen by the player 101), the types of games played by the player 101, and the like.

### Game Systems, Social Networks, and Social Graphs

In an online multiplayer game, players 101 may control player characters (PCs), a game engine controls non-player characters (NPCs) and game features, and the game engine also manages player character states and a game state and tracks the states for currently active(i.e., online) players 101 and currently inactive (i.e., offline) players 101. A player character can have a set of attributes and a set of friends associated with the player character. As used herein, the term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), etc. The game engine may use player character states to determine the outcomes of game events, sometimes also considering set or random variables. Generally, a player character's probability of having a more favorable outcome is greater when the player character has a better state. For example, a healthier player character is less likely to die in a particular encounter relative to a less healthy player character or non-player character. In some embodiments, the game engine can assign a unique client identifier to each player 101.

In particular embodiments, a player 101 may access particular game instances of an online game. A game instance is a copy of a specific game play area that is created during runtime. In particular embodiments, a game instance is a discrete game play area where one or more players 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible only by specific players 101) or non-exclusive accessible by any player 101). In particular embodiments, a game instance is populated by one or more player characters controlled by one or more players 101 and one or more in-game objects controlled by the game engine. When accessing an online game, the game engine may allow a player 101 to select a particular game instance to play from a plurality of game instances. Alternatively, the game engine may automatically select the game instance that the player 101 will access. In particular embodiments, an online game comprises only one game instance that all players 101 of the online game can access.

In particular embodiments, a game engine can interface with a social graph. Social graphs are models of connections between entities (e.g., individuals, users, contacts, friends, players 101, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player 101 or player character in an online multiplayer game, though this disclosure may apply to any suitable social graph users.

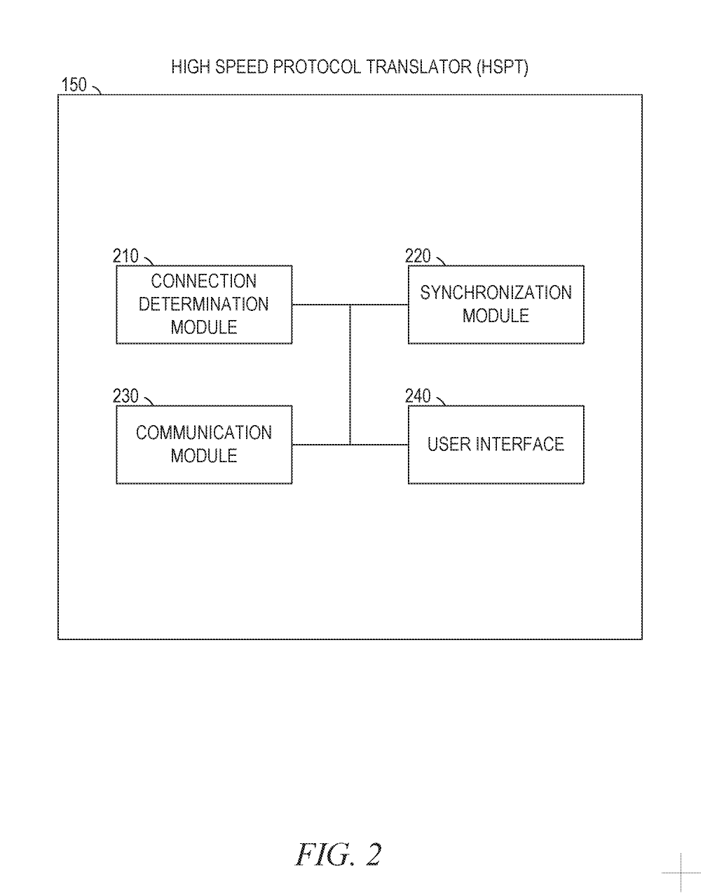

FIG. 2 is a block diagram illustrating components of a HSPT 150, according to one example embodiment. In some instances, the game networking system 140 can include the HSPT 150. The HSPT 150 in this example embodiment includes a connection determination module 210, a synchronization module 220, a communication module 230, and a user interface 240.

In various example embodiments, the connection determination module 210 can determine the connection type from the priority list based on the connection parameters of each connection type. For example, if packet loss for the UDP is below a predetermined threshold, then the connection determination module 210 can determine to use the UDP connection. Alternatively, if the packet loss for the UDP connection is above a predetermined threshold, then connection determination module 210 can use the TCP connection.

In various example embodiments, the synchronization module 220 can automatically synchronize a game session when the user switches from a first wireless connection to a second wireless connection. The synchronization module 220 allows the game session to seamlessly continue without the user having to manually reload or resynchronize the game session. The synchronization module 220 can access session data, configuration data, game data store, and game session management to automatically synchronize the game session when a user transitions from a first connection to a second connection.

In various example embodiments, the communication module 230 is a hardware-implemented module that controls, manages, and stores information related to sending packets to a client system 130, game networking system 140, or social networking system 120. The user interface 240 is a module that can receive user input. The user input can include user parameters that the HSPT can use to determine the connection type from the priority list.

The modules 210-240 are configured to communicate with each other (e.g., via a bus, shared memory, or a switch). Any one or more of the modules 210-240 described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

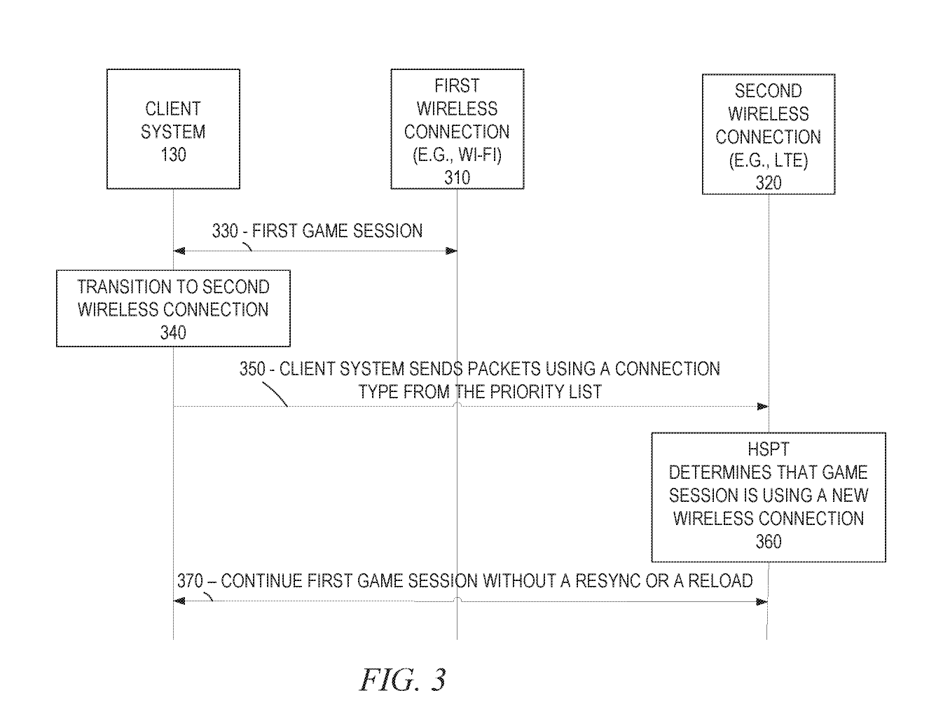

FIG. 3 illustrates a diagram of the client system 130 seamlessly communicating with the game networking system 140 (not shown in FIG. 3) using the HSPT 150 when transitioning from a first wireless connection 310 to a second wireless connection 320, according to various embodiments.

As previously discussed, when the user transitions from a first wireless connection 310 to a second wireless connection 320, the user gets disconnected, and the game session simply ends. The user may have to resynchronize, reload the browser, re-login, or restart the game application. However, with the HSPT, the game session continues seamlessly when the user transitions from a first wireless connection 310 to a second wireless connection 320.

To illustrate, at operation 330, the client system 130 can establish a game session with the game networking system 140 using the first wireless connection 310. For example, the first wireless connection 310 can be the home Wi-Fi connection. From example, the client system 130 can be a mobile device of a user.

At operation 340, the client system 130 can transition to a second wireless connection 320. Continuing with the example, the user can leave the home Wi-Fi connection, start driving, and connect to the Internet using the user's cellular connection (e.g., LTE). When the client system 130 transitions to a second wireless connection 320, the first wireless connection 310 is disconnected. Additionally, the IP address of the client system 130 changes. In current implementations, a change in IP address can disconnect the game session. However, according to some embodiments, by using a unique session identifier, the game session stays connected even when the IP address changes.

Therefore, in previous implementations, the game networking system 140 may end the game session since the first connection was disconnected, and the game networking system 140 was not receiving any data from the IP address of the client system 130.

However, with the HSPT implementations, the client system 130, using the HSPT 150, can continue sending packets using a connection type from the priority list at operation 350. The connection type in the priority list can include UDP, TCP, HTTP, Socks, and so on. For example, using UDP, the client system 130 or the HSPT 150 can continue sending packets to the game networking system 140 regardless of the internet connection or the radio state.

At operation 360, the HSPT 150 or the game networking server 140 can determine that the data received at operation 350 belongs to the first game session. The HSPT 150 or the game networking server 140 can determine that client system 130 is using a new wireless connection with a new IP address.

Subsequently, at operation 370, the HSPT 150 can continue the first game session based on the determination at operation 360. The first game session can continue without a resynchronization or a reload by the user of client system 130. The game networking system 140 can determine the game session and the client system 130 without a resynchronization.

Additionally, based on the acknowledgment received by the client system 130, the game networking system 140 or the HSPT 150 can resend all the missed data using the second wireless connection 320. For example, the game networking system 140 or the HSPT 150 can resend all packets that the client system 130 did not send back an acknowledgement for.

Additionally, the reconnection of the game session using the second wireless connection 320 is transparent to the user with the help of the HSPT 150.

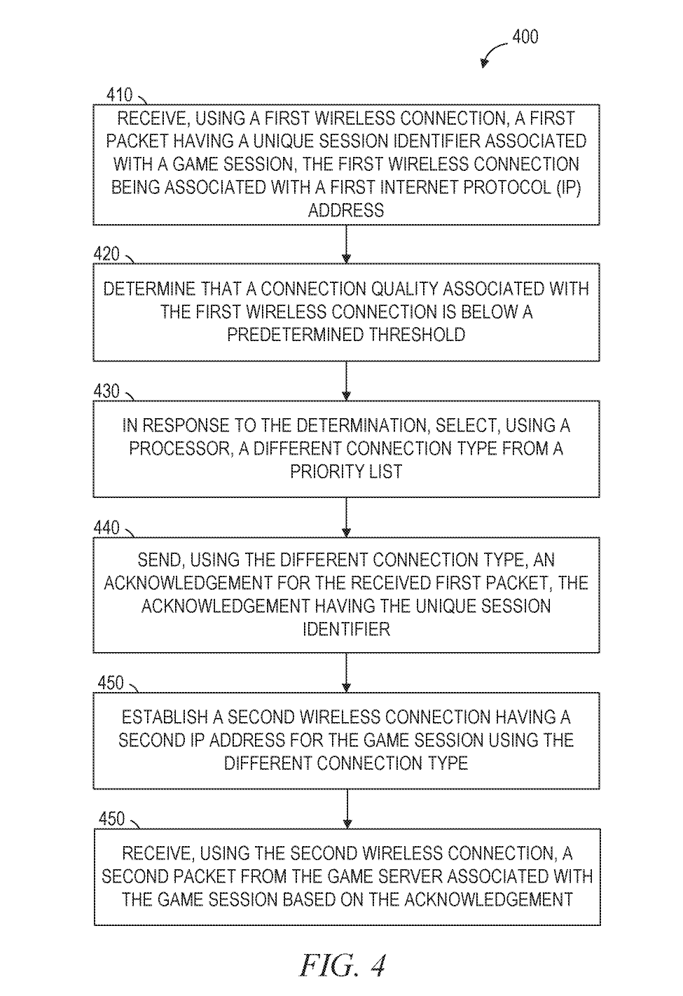

FIG. 4 is a flowchart showing an example method 400 of seamlessly maintaining a game session when a client device (e.g., client system 130) transitions from a first wireless connection to a second wireless connection, according to some embodiments.

In some instances, the method 400 can be initiated when the HSPT 150 establishes a game session with a game server (e.g., game networking system 140). For example, the client system 130 establishes a game session using the home Wi-Fi connection. As illustrated at operation 330 of FIG. 3, the client system 130 can establish a game session using a first wireless connection 310, which is associated with a first IP address.

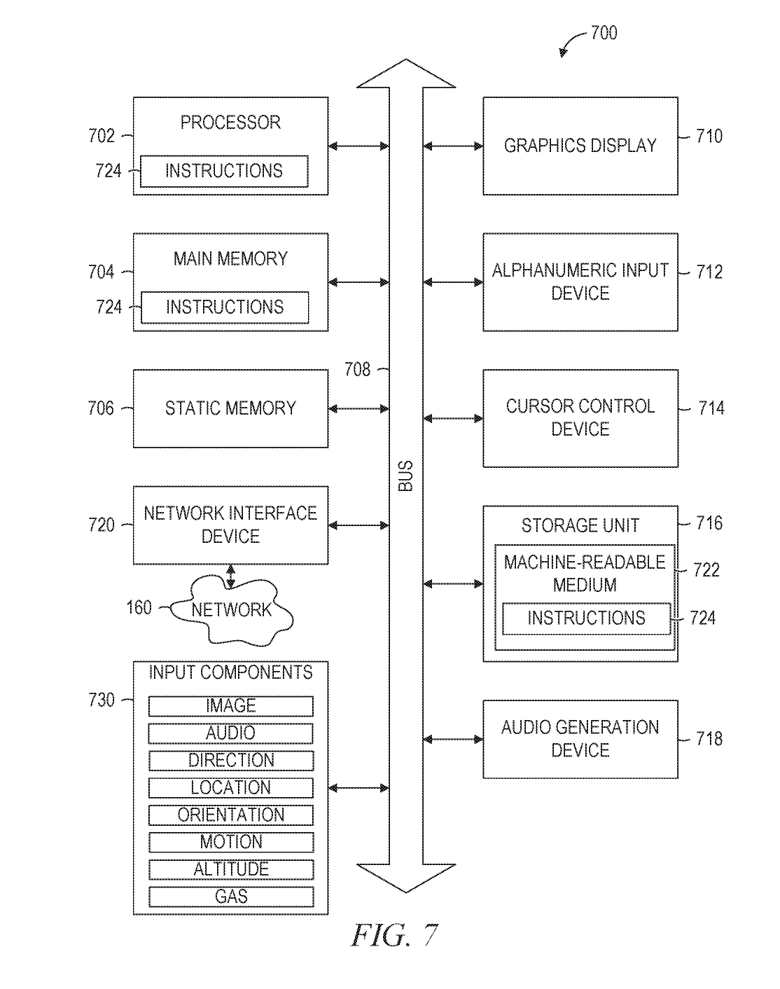

At operation 410, the client system 130 receives a first packet having a unique session identifier associated with the game session. The first packet can be sent by the game networking system 140 and received by the client system 130 using the first wireless connection 310. As previously mentioned, the first wireless connection 310 is associated with a first Internet Protocol (IP) address. For example, a network interface device 720, as later described in FIG. 7, can receive the first packet at operation 410.

At operation 420, the client system 130 determines that a connection quality associated with the first wireless connection 310 is below a predetermined threshold. In some instances, the connection quality can be either excellent, good, acceptable, or bad. The predetermined threshold can be set by an administrator at either good, acceptable, or bad. Additionally, the connection quality is determined based on a packet loss rate. For example, when the packet loss rate is greater than ten percent, then the connection quality is bad. Continuing with the example, when the packet loss rate is greater than five percent, then the connection quality is average; when the packet loss rate is greater than 2.5 percent, then the connection quality is good; and when the packet loss rate is greater than five percent, then the connection quality is excellent. Packet loss rate may be measured as frame loss rate defined as the number of packets lost (e.g., not received) from the game networking system 140 to the client system 130 divided by the total number of packets sent by the game networking system 140. For example, processor 702, as later described in FIG. 7, can perform the determination at operation 420.

In some instances, the first wireless connection 310 is considered lost or disconnected when the connection quality is below the predetermined threshold (e.g., bad connection quality).

At operation 430, the client system 130 selects, using a processor, a different connection type from a priority list in response to the determination that the connection quality is below the predetermined threshold. The different connection type is different than a connection type associated with the first wireless connection 310. The different connection type is utilized by the client system 130 to set up another connection with the game networking system 140. In one example, the different connection type is a TCP connection, while the connection type of the first wireless connection 310 is a UDP connection. In another example, the different connection type is a UDP connection, while the connection type of the first wireless connection 310 is a TCP connection. In some instances, processor 702, as later described in FIG. 7, can perform the selection at operation 430.

According to some embodiments, the different connection type in the priority list can include, but is not limited to, a user datagram protocol (UDP) connection, a transmission control protocol (TCP) connection, socket secure (SOCKS) connection, a Hypertext Transfer Protocol (HTTP) connection, a Hypertext Transfer Protocol Secure (HTTPS) connection, a secure Web Socket connection, and a plaintext Web Socket connection.

At operation 440, the client system 130 sends, using the different connection type, an acknowledgement (ACK) for the received first packet. The acknowledgement is sent to the game networking system 140 in order to set up a second wireless connection, e.g., second wireless connection 320. The acknowledgement can include the unique session identifier. For example, the network interface device 720, as later described in FIG. 7, can send the acknowledgment at operation 440.

In some instances, the unique session identifier allows the game networking system 140 to identify that the acknowledgment is associated with the game session initiated at operation 410. The unique session identifier is received in the first packet at operation 410. Additionally, the acknowledgement can include a reference number to the first packet. Using the acknowledgement, the HSPT 150 included in the game networking system 140 can determine which packets were not received by the client system 130 and resend the unreceived packets.

At operation 450, the client system 130 establishes a second wireless connection (e.g., second wireless connection 320) having a second IP address for the game session using the different connection type. The second wireless connection is established between the client system 130 and the game networking system 140. The game session initiated at operation 410 is seamlessly transitioned from the first wireless connection to the second wireless connection using the HSPT 150. Without the HSPT, the game session may have been disconnected, and the user would have needed to resynchronize and reinitiate the game session in order to continue playing. The network interface device 720, as later described in FIG. 7, can establish the second wireless connection at operation 450.

Additionally, the first wireless connection can be disconnected by either the client system 130 or the game networking system 140 in response to establishing the second wireless connection.

At operation 460, the client system 130 receives, using the second wireless connection, a second packet from the game server associated with the game session based on the acknowledgement. The network interface device 720, as later described in FIG. 7, can receive the second packet at operation 460.

In some instances, the second packet was sent using the first wireless connection but not received by the client system 130 due to the connection quality associated with the first wireless connection being below the predetermined threshold. For example, the second packet may have been previously sent by the game networking system 140 using the first wireless connection but not received by the client system 130 because of a bad connection quality (e.g., dropped packet). By seamlessly reconnecting the game session during the transition from the first wireless connection to the second wireless connection, the game networking system 140 can resend the packets that the client system 130 has not received yet. The acknowledgment can include a reference number to the first packet that allows the game networking system 140 to determine which packets (e.g., second packet) to resend.

For example, the acknowledgement may have associate a reference number with the first packet, such as a variable labeled as ‘X’, and the second packet is the subsequent packet to be received with regards to the reference number. The second packet can be next packet after the first packet and have a reference number that is ‘X-+1.’

In some instances, the acknowledgement includes a unique device identifier, wherein the second wireless connection is established based on the unique device identifier matching a unique device identifier associated with the first wireless connection. In some instances, the unique device identifier is associated with the client system 130. For example, the unique device identifier can be the International Mobile Station Equipment Identity (IMEI) of a mobile device playing the game. For security reasons (e.g., to prevent hacking of the game session), the game networking system 140 may only automatically transition the game session from the first wireless connection to the second wireless connection when the client system 130 is the same device.

According to some embodiments, the first packet and the second packet are received from a game server, such as the game networking system 140. Additionally, the acknowledgement is sent at operation 440 using a network interface device, such as the network interface device 720.

In one example, the first wireless connection can be a wireless local area network (WLAN), and the second wireless connection can be a mobile carrier wireless service. For example, the client system 130 can transition from the user's home wireless network to the user's cellular service when the user moves from the house to the car.

In another example, the first wireless connection can be a WLAN, and the second wireless connection can be another WLAN.

In some instances, the first wireless connection can be a home mobile carrier wireless service, and the second wireless connection can be a roaming mobile carrier wireless service.

FIG, 5 is a flowchart showing another example method 500 of seamlessly maintaining a game session when a client device (e.g., client system 130) transitions from a first wireless connection to a second wireless connection, according to some embodiments.

At operation 510, the HSPT 150 can establish a first game session with a game server using a first wireless connection with a first IP address. For example, the client system 130 can establish a game session using the home Wi-Fi connection. As illustrated at operation 330 of FIG. 3, the client system 130 can establish a first game session using a first wireless connection 310.

At operation 520, the HSPT 150 can send, using a connection type from a priority list, new data associated with the first game session when the first wireless connection is lost. As illustrated at operation 350 of FIG. 3, the client system 130 can continue to send packets using a connection type from the priority list. The priority list can be UDP, TCP, HTTP, Socks, and so on. The HSPT 150 can determine the connection type from the priority list based on the connection parameters of each connection type. For example, when the UDP packet loss is below a threshold, the HSPT can use the UDP connection type.

At operation 530, the HSPT 150 can establish a second wireless connection (e.g., the second wireless connection 320 in FIG. 3) with a second IP address. Continuing with the example, when the client system 130 is outside of the home, the client system 130 can establish an internet connection using the cellular connection (e.g., LTE).

At operation 540, the HSPT 150 can receive, from the game server 140, an acknowledgement of the first game session based on the new data. For example, when the game server 140 receives the new data, the game server 140 can determine that the client system 130 has transitioned to a second wireless connection. Based on the determination, the game server 140 keeps first game session alive and notifies the client system 130 and the HSPT 150 that the game session can be automatically reestablished.

At operation 550, the HSPT 150 can reestablish the first game session using the second wireless connection based on the received acknowledgement. As illustrated at operation 370 of FIG. 3, the client system 130 can reestablish and continue the first game session without a manual resynchronization or a reload.

According to another embodiment, the first connection, at operation 510, can be a wired Internet connection, and the second connection, at operation 530, can be a wireless connection. in this example, the client system 130 is transitioning from wired to wireless, such as when a portable laptop is removed from its Ethernet connection and falls back to the wireless transceiver. Using the techniques described in method 400, the client system 130 can seamlessly maintain the first game session when transitioning from a wired connection to a wireless connection.

In some instances, the connection type at operation 520 is a user datagram protocol (UDP) connection. Alternatively, the connection type can be transmission control protocol (TCP) connection, a socket secure (SOCKS) connection, a Hypertext Transfer Protocol (HTTP) connection, a Hypertext Transfer Protocol Secure (HTTPS) connection, a secure WebSocket connection, or a plaintext WebSocket connection.

In some instances, the first wireless connection for method 500 is a wireless local area network (WLAN), and the second wireless connection for method 500 can be a mobile carrier wireless service. Alternatively, the second wireless connection for method 500 can be another WLAN.

In some instances, the first wireless connection is a home mobile carrier wireless service, and the second wireless connection is a roaming mobile carrier wireless service.

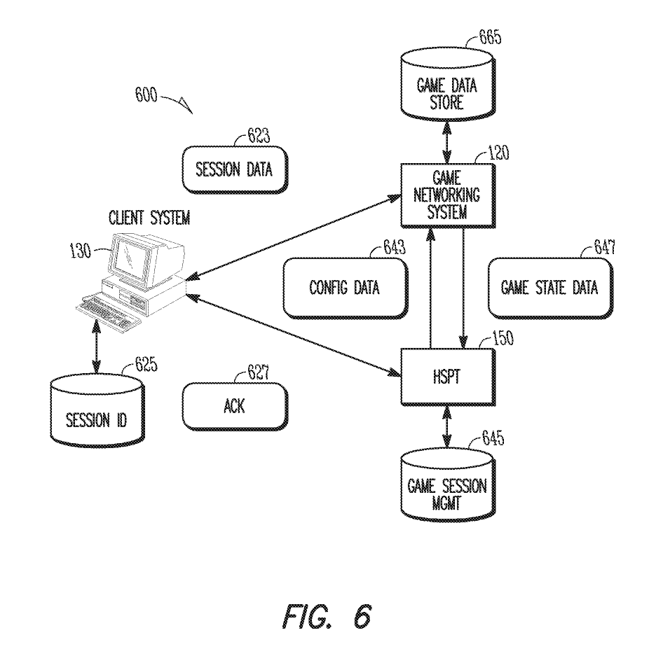

FIG. 6 illustrates an example data flow between the components of a system 600. In particular embodiments, the system 600 can include the client system 130, the HSPT 150, and the game networking system 140 (i.e., online game system). In some instances, the HSPT 150 is part of the game networking system 140, and in other instances, the HSPT 150 is a standalone component. The components of the system 600 can be connected to each other in any suitable configuration, using any suitable type of connection. The components may be connected directly or over any suitable network.

The client system 130, HSPT 150, and game networking system 140 can each have one or more corresponding data stores, such as a session ID 625, a game session management 645, and a game data store 665, respectively. The HSPT 150 and the game networking system 140 can also have one or more servers that can communicate with the client system 130 over an appropriate network (e.g., network 160) in order to seamlessly continue a game session when the client system 130 transitions from a first wireless network to a second wireless network. The HSPT 150 and the game networking system 140 can have, for example, one or more servers for communicating with the client system 130 via the different connection types in the priority list. Similarly, the HSPT 150 and the game networking system 140 can have one or more mobile servers for communicating with the client system 130 via a mobile network (e.g., GSM, PCS, Wi-Fi, WPAN, etc.). In some embodiments, one server may be able to communicate with the client system 130 over both the Internet and a mobile network. In other embodiments, separate servers can be used.

The client system 130 can receive and transmit session data 623 (e.g., first packet, second packet) to and from the game networking system 140. The session data 623 can include, for example, webpages, messages, game inputs, game displays, HTTP packets, data requests, transaction information, updates, and other suitable data. At some other time, or at the same time, the game networking system 140 can communicate configuration data 643 and game state data 647 (e.g., game state information, game system account information, page info, messages, data requests, updates, etc.) with other networking systems, such as the HSPT 150. The HSPT 150 can use the configuration data 643 and the game state data 647 to seamlessly transition the client system 130 from a first wireless connection to a second wireless connection.

The client system 130 can also receive and transmit an acknowledgement (ACK) 627 to and from the HSPT 150. This ACK 627 can include, for example, attributes associated with the game session, such as the user's authentication token, a unique session identifier (e.g., Session ID 625), and a reference number for the packet received via the first wireless connection. The authentication token can be used by the HSPT 150 for security purposes to ensure that the actual user is accessing the game session. The unique session identifier (e.g., session ID 625) can allow the HSPT 150 to determine the correct game session to transition the client system 130 to, given that the IP address changes when the client system 130 transitions from the first wireless connection to the second wireless connection. Additionally, the reference number allows the HSPT 150 to resend the packets that may not have been received by the client system 130 via the first wireless connection.

Communication among the client system 130, the HSPT 150, and the game networking system 140 can occur over any appropriate electronic communication medium or network 160 using any suitable communications protocols. For example, the client system 130, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end systems described herein may use a variety of higher layer communications protocols, including client-server (or request-response) protocols, such as the Hypertext Transfer Protocol (HTTP) and other communications protocols, such as HTTPS, FTP, SNMP, TELNET, and a number of other protocols. The protocols described herein can be examples of the different connection types in the priority list described in method 400. In some embodiments, no protocol may be used and, instead, transfer of raw data may take place via TCP or User Datagram Protocol. In addition, a server in one interaction context may be a client in another interaction context. In particular embodiments, the information transmitted between hosts may be formatted as Hypertext Markup Language (HTML) documents. Other structured document languages or formats can be used, such as XML and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, the ACK 627 can include a set of game state parameters. In particular embodiments, the game state is maintained in a database as a serialized, unstructured string of text data as a so-called binary large object (BLOB). When a player 101 accesses an online game on the game networking system 140, the BLOB containing the game state for the instance corresponding to the player 101 can be transmitted to the client system 130 for use by a client-side executable. In particular embodiments, the client-side executable may be a Flash-based game, which can de-serialize the game state data in the BLOB. As the player 101 plays the game, the game logic implemented at the client system 130 maintains and modifies the various game state parameters locally. The client-side game logic may also batch game events, such as mouse clicks, and transmit these events to the game networking system 140. The game networking system 140 may itself operate by retrieving a copy of the BLOB from a database or an intermediate memory cache (memcache) layer. The game networking system 140 can also de-serialize the BLOB to resolve the game state parameters and execute its own game logic based on the events in the batch file of events transmitted by the client to synchronize the game state on the server side. The game networking system 140 may then re-serialize the game state, now modified, into a BLOB and pass this to a memory cache layer for lazy updates to a persistent database.

With a client-server environment in which the online game may run, one server system, such as the game networking system 140, may support multiple client systems 130. At any given time, there may be multiple players 101 at multiple client systems 130 all playing the same online game. In practice, the number of players 101 playing the same game at the same time may be very large. As the game progresses with each player 101, multiple players 101 may provide different inputs to the online game at their respective client systems 130, and multiple client systems 130 may transmit multiple player inputs and/or game events to the game networking system 140 for further processing. In addition, the multiple client systems 130 may transmit other types of application event data to the game networking system 140.

FIG. 7 is a block diagram illustrating components of a machine 700 (e.g., client system 130, social networking system 120, game networking system 140, HSPT 150), according to some example embodiments. The machine 700 is able to read instructions 724 from a machine-readable medium 722. (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a distributed (e.g., peer-to-peer) network environment. The machine 700 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine 700 is illustrated, the term “machine” shall also be taken to include any collection of machines 700 that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724, such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712. (e.g., a keyboard or keypad), a cursor control device 714 (e.g., a mouse, a touchpad, a trackball, a joystick, a motion sensor, an eye tracking device, or another pointing instrument), a storage unit 716, an audio generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered machine-readable media 722 (e.g., tangible and non-transitory machine-readable media). The instructions 724 may be transmitted or received over the network 160 via the network interface device 720. For example, the network interface device 720 may communicate the instructions 724 using any one or more transfer protocols (e.g., HTTP, TCP, UDP).

In some example embodiments, the machine 700 may be a portable computing device, such as a smartphone or tablet computer, and may have one or more additional input components 730 (e.g., sensors or gauges). Examples of such input components 730 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 730 may be accessible and available for use by any of the modules described herein.

As used herein, the term “memory” refers to a machine-readable medium 722 able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable readable medium” should be taken to include a single medium or multiple media (e.g., a centralized or distributed database, or associated caches and servers) able to store the instructions 724. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 722 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors 702) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor 702. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 702 configured by software to become a special-purpose processor, the general-purpose processor 702 may be configured as respectively different special-purpose processors (e.g., comprising different hardware modules) at different times. Software (e.g., a software module) may accordingly configure one or more processors 702, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 708) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 702 that are temporarily configured (e.g., by software) or permanently configured to perform the relevant operations. Whether temporarily or permanently configured, such processors 702 may constitute processor-implemented modules that operate to perform one or more operations or functions described herein. As used herein, “processor-implemented module” refers to a hardware module implemented using one or more processors 702.

Similarly, the methods described herein may be at least partially processor-implemented, a processor 702 being an example of hardware. For example, at least some of the operations of a method may be performed by one or more processors 702 or processor-implemented modules. As used herein, “processor-implemented module” refers to a hardware module in which the hardware includes one or more processors 702. Moreover, the one or more processors 702 may also operate to support performance of the relevant operations in a “cloud computing” environment or as a “software as a service” (SaaS). For example, at least some of the operations may be performed by a group of computers (as examples of machines 700 including processors 702), with these operations being accessible via a network 160 (e.g., the Internet) and via one or more appropriate interfaces (e.g., an application programming interface (API)).

The performance of certain operations may be distributed among the one or more processors 702, not only residing within a single machine 700, but deployed across a number of machines 700. In some example embodiments, the one or more processors 702 or processor-implemented modules may be located in a single geographic location (e.g., within a home environment, an office environment, or a server farm). In other example embodiments, the one or more processors 702 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 700. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 700 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A computer-implemented method, comprising:
receiving, using a first wireless connection, a first packet having a unique session identifier from a game server associated with a game session, the first wireless connection being associated with a first internet protocol (IP) address;
determining that a connection quality associated with the first wireless connection is below a predetermined threshold;
in response to the determination, selecting, using a processor, a different connection type from a priority list, the different connection type being different than a connection type associated with the first wireless connection;
sending, using the different connection type, an acknowledgement for the received first packet, the acknowledgement having the unique session identifier;
establishing a second wireless connection having a second IP address for the game session using the different connection type; and
receiving, using the second wireless connection, a second packet from the game server associated with the game session based on the acknowledgement.

2. The method of claim 1, wherein the acknowledgement includes a unique device identifier, and wherein the second wireless connection is established based on the unique device identifier matching a unique device identifier associated with the first wireless connection.

3. The method of claim 1, wherein the acknowledgement includes a reference number associated with the first packet, and the second packet is a subsequent packet with regards to the reference number.

4. The method of claim 1, wherein the first wireless connection is disconnected in response to establishing the second wireless connection.

5. The method of claim 1, wherein the connection quality is determined based on a packet loss rate.

6. The method of claim 1, wherein the first wireless connection is lost based on the connection quality being below the predetermined threshold.

7. The method of claim 1, wherein the first packet and the second packet are received from a game server.

8. The method of claim 1, wherein the acknowledgement is sent using a network interface device.

9. The method of claim 1, wherein the second packet was sent using the first wireless connection but not received due to the connection quality associated with the first wireless connection being below the predetermined threshold.

10. The method of claim 1, wherein the different connection type is user datagram protocol (UDP), and wherein the first wireless connection has a transmission control protocol (TCP) connection.

11. The method of claim 1, wherein the different connection type is transmission control protocol (TCP), and wherein the first wireless connection has a user datagram protocol (UDP) connection.

12. The method of claim 1, wherein the priority list includes a socket secure (SOCKS) connection, a Hypertext Transfer Protocol (HTTP) connection, and a Hypertext Transfer Protocol Secure (HTTPS) connection.

13. The method of claim 1, wherein the priority list further includes a secure Web Socket connection and a plaintext WebSocket connection.

14. The method of claim 1, wherein the first wireless connection is a wireless local area network (WLAN).

15. The method of claim 14, wherein the second wireless connection is a mobile carrier wireless service.

16. The method of claim 14, wherein the second wireless connection is another WLAN.

17. The method of claim 1, wherein the first wireless connection is a home mobile carrier wireless service and the second wireless connection is a roaming mobile carrier wireless service.

18. A system comprising:
a network interface configured to receive, using a first wireless connection, a first packet having a unique session identifier associated with a game session, the first wireless connection being associated with a first internet protocol (IP) address;
one or more computer processors configured to:
determine that a connection quality associated with the first wireless connection is below a predetermined threshold; and
in response to the determination, selecting, using a processor, a different connection type from a priority list, the different connection type being different than a connection type associated with the first wireless connection; and
the network interface further configured to:
send, using the different connection type, an acknowledgement for the received first packet, the acknowledgement having the unique session identifier;
establish a second wireless connection having a second IP address for the game session using the different connection type; and
receive, using the second wireless connection, a second packet from a game server associated with the game session based on the acknowledgement.

19. The system of claim 18, wherein the first wireless connection is a home mobile carrier wireless service, and the second wireless connection is a roaming mobile carrier wireless service.

20. A non-transitory machine-readable storage medium comprising instructions that, when executed by one or more processors of a machine, cause the machine to perform operations comprising:
receiving, using a first wireless connection, a first packet having a unique session identifier associated with a game session, the first wireless connection being associated with a first internet protocol (IP) address;
determining that a connection quality associated with the first wireless connection is below a predetermined threshold;
in response to the determination, selecting, using a processor, a different connection type from a priority list, the different connection type being different than a connection type associated with the first wireless connection;
sending, using the different connection type, an acknowledgement for the received first packet, the acknowledgement having the unique session identifier;
establishing a second wireless connection having a second IP address for the game session using the different connection type; and
receiving, using the second wireless connection_{;} a second packet from a game server associated with the game session based on the acknowledgement.
